(19) United States
(12) Patent Application Publication
(10) Pub. No.: US 2005/0170320 A1
(43) Pub. Date: Aug. 4, 2005

(54) Accelerated Experiential Learning (AEL)

(75) Inventor: Robert Brent Powell, Houston, TX (US)

Correspondence Address: ROBERT BRENT POWELL, 7614 EVERGREEN BROOK WAY, HOUSTON, TX, 77095, US

(73) Assignee: Robert Brent Powell, Houston, TX (US)

(21) Appl. No.: 10/708,025

(22) Filed: Feb. 3, 2004

(51) Int. Cl. G09B 19/00

(52) U.S. Cl. 434/219; 434/362; 434/118

(57) ABSTRACT

This patent describes the process and application of Accelerated Experiential Learning (AEL). AEL is a process for extracting key information sets used by experts to make decisions and produce solutions. The chunked data sets are presented to the learner using an electronic delivery methodology to provide the extracted associated information sets to novices allowing them to gain dramatically in the associated information from which the experience was derived. The associated or chunked data allows the learner's brain to develop or refine the reference information and use it within minutes. The process elevates the performance of the learner as if they had acquired the same experience in a standard trial and error fashion of months or years. The process produces new internalized usable experience unavailable through any other means besides the common development of experience through trial and error over time.

### FEDERAL RESEARCH STATEMENT

No federal funds or grants of any kind were used in the development of this process, research or development. It was all done solely at the inventor's expense

### BACKGROUND OF INVENTION

Accelerated Experiential Learning fits into the general category of classification 434. However, The nature of the process for high-speed experience transfer among people is so unique that there are no similar classifications beyond general education. Neither is there, after extensive searches, any similar techniques, processes or other inventions addressing the same issue. Experience is typically acquired by hands on, first hand exposure to a field, activity, skill, art or pool of knowledge in sufficient quantity to obtain mastery. In most cases the time required is many months or years. Guided instruction typically eliminates the need for an individual to derive ideas or processes for themselves. It can also deliver or expand knowledge. In some mentoring forms of education an expert guides learners in steps. Standard training or education does not provide enough exposure to critical information to allow the achievement or mastery of more than the knowledge itself. The application of the knowledge still requires experience to ensure the right techniques or knowledge sets are applied at the correct time and in the correct way. An example would be an expert in the science of internal combustion engines who cannot repair a car, or a weapons expert who cannot prioritize targets in the field under fire quickly enough to survive. An expert or master has so much exposure to critical information and its application that the answers to key questions are solved without apparent linear steps. Experts in any field can arrive at correct assessments quickly and accurately through application of information known as experience. AEL is a unique process that allows the systematized identification of the key recognition cues used by experts in the comparison, analysis, recognition, problem solving and decision making that sets them apart and through a software delivery methodology transfers chunks of information to non experts allowing the systemized sorting, tagging and associations needed to make expert decisions. The data is transferred at the sensory level limited only through the interface. With current off-the-shelf-technologies the transfer is restricted to auditory and visual information, but experience transfer through AEL can also be applied to taste, touch, and smell as well as combinations of all five limited only by available technology. AEL specifically addresses the rapid identification and transfer of key information components to non-experts accelerating the development of experience. It reduces the time required to acquire experience from months or years to minutes and hours. It addresses the need to achieve a greater level of skill and competency without the usual extensive blocks of time acquired to develop an expert. It can be applied in single or multiple steps to provide and organize the information required by the brain to make decision at an expert level.

### SUMMARY OF INVENTION

The Object of AEL is to significantly reduce the time required to possess expert levels of experience. The sensory cues used by experts to identify patterns from which they make decisions and reach conclusions are placed in any format appropriate to human senses that can be controlled by computer. The information is placed in a software program that can be written in any language that allows the correct functionality. The learner or user is supplied with the appropriate sensory information and required to identify key relationships pertaining to the subject matter. The time of exposure varies from more to less as the level of difficulty increases. Regardless of level of difficulty, after the learner believes they know the key recognition point, the stimulus information is eliminated and the learner is required to specify the correct application of the information. Feedback as to the correctness and incorrectness is supplied immediately and the learner repeats the process. As identification speed and accuracy improve the skill level required is raised until an expert level is achieved. The stimuli of information sets presented by the AEL software is selected to represent the points on a scale of comparison representing several possible conditions of right or acceptable and clearly delineating wrong or unacceptable. AEL is presented in a game like format to reduce anxiety in the learners and uses stimuli that have been simplified as much as possible without losing the key elements and combinations of elements that define the chunked information necessary to make the key comparisons. Learners speed and accuracy is reported as a score for individual assessment or when experiencing the process in groups. An example of AEL can be drawn from the sport of Tennis. An expert must anticipate what the opponent will do. The chunks of cues an expert uses to determine the opponent's next move are based on hundreds of variables relating to eye movement, shoulder position, arm position, hip orientation, foot position and many more. There is not enough time on a court to consider the combinations consciously. An expert must spend hours on the court daily over a period of years to amass the experiential data necessary to perceive and compare all important variables required to recognize the opponent's intent, interpret it and act upon it. AEL has been demonstrated to advance the experientially based skills of a player from six months to a year after using the software to establish and redefine cues in the fashion developed by an expert. AEL is both a methodology for isolating key referencing cues and delivering those cues in the fashion internalizable by a learner.

### DETAILED DESCRIPTION

Research into learning models and differences in learning speed among individuals has been the subject of much attention since the introduction of the Model of Mastery Learning. This model attempts to formulate the degree of learning as equal to the amount of time spent on a task divided by the amount of time needed to learn the task. By increasing time, mastery can be achieved by 80 percent of students to the same levels as the top 20% in typical or non-mastery learning conditions. The obvious answer to providing a higher percentage of student mastery would be unlimited time. Unlimited learning time is rarely available. If time is held constant in the equation, so that all students have equal amounts for learning, students will tend to achieve in a normal distribution of high, medium, and low scores. To bring less able learners up to the desired mastery level, additional time must be provided for both the learners and instructors. When compared to traditional academic learning programs, mastery programs produce positive improvement in both student attitude and student achievement. Personalized systems of instruction (PSI) include mastery but also utilize immediate feedback, human tutors and proctors, and the division of learning into small units with frequent testing. Students should be allowed to learn at their own pace with intervention by tutors only where necessary. Evidence also indicates that even individuals who show great comprehension speed in some areas may learn inadequately in others. So the speed at which different students learn may differ by the type of learning required and the time available for learning. Time availability is directly related to achievement, that is, the more time students have to learn the larger a percentage of them will reach mastery. The time required for achieving mastery, if not available, precludes learners from achieving their best without other forms of intervention. The use of computers provides the capability to make learning interactive while allowing students to learn by doing, receive feedback, constantly improve their understanding and, at the same time, build new knowledge in a shorter block of time. Some researchers now say that the use of well-designed technological tools supporting complex activities may reorganize components of human activity into different structures than they had in previous designs. These new tools make it possible for students to learn and perform in far more complex ways than before. As we learn, we establish memories. Those memories are the foundations upon which we build expectancies. To gain mastery in a limited amount of time, the time required for the acquisition of the knowledge base must be reduced. Establishing the foundational data is critical as that data becomes the informational pool we call understanding or experience. One layer of foundation learning, after complete internalization, may have parts clumped into associated data. That clumped data becomes the individual data units of the next layer of foundational data. The ability to interpret large bodies of experience is based upon the ability to “chunk” knowledge. More experience or knowledge allows individuals to more clearly perceive information in recognizable “chunks”. Sorting information in “chunks” is faster and more efficient. Over a variety of topics, studies have shown that novices do not perform as well as those with enough expertise to developed a “sensitivity” to meaningful information patterns. Graphics and other visualizations of information can help people learn. Learning requiring more than rote has typically been acquired through on-the-job training, apprenticeship, and/or other forms of repetitious practice. Learning by rote does not promote spatial, experiential learning and can actually inhibit learners' understanding. Use and understanding are best achieved when skills and facts are placed in natural, spatial memory. By having the information in one well-organized area, the computer spends less time searching, retrieving, and assembling the needed information. The brain appears to work in a similar fashion. The use of technologies has been employed extensively in the military in the form of simulators. The simulators are used to help students develop expertise in the conditions that can affect equipment such as tanks and aircraft. Simulation is restricted for the most part to the learning of procedures in response to a dangerous condition. AEL ties together the recognition patterns required to recognize the dangerous condition and know which procedure to apply. The goal is to have students internalize much of the information necessary to execute correct “instinctive” decisions. Instinctive decisions are those analyses where conscious thought was not required to reach a correct conclusion and, in fact, conscious thought may have hampered performance. When asked to explain solution sets, experts usually mentioned laws and rules and discussed how they applied to a specific situation, while novices relied on formulas and their manipulations to arrive at solutions. Experts in physics will recall equations in sets. The recall of one equation, or set of equations, produces a rapid sequence of recalling related equations. Novices recall equations in more evenly spaced time intervals suggesting a linear, or sequential search of memory. The same pattern has been shown in the field of history, and other social sciences. The amount of information or stimuli a person can process at any one time is limited. The more internalized and automatic the processing the more time the individual will have to attend to other tasks or variables. Many environments designed to provide instruction fall short of providing the fluency needed to successfully perform cognitive tasks. One of the most important aspects of learning is the progress toward fluency and then to automatic recognition of problem types in particular domains. This fluency allows rapid retrieval of solutions or interpretations from memory. The implementation of instructional procedures that speed pattern recognition from fluency to automatic response are important to coping with the mass of information required to produce expert level behavior. Traditionally experience is garnered through trial and error over significant amounts of time. AEL removes the majority of the time element by supplying the brain the key information patterns and chunks it would normally have to assimilate on its own through trial and error. It also aids the brain in associating the information for future reference. Initial investigation must be made through observation or interview of experts on how they base their decisions and the important referential data bits they use. Often they are unaware, consciously, of how they arrive at recognition through use of experience based conditions and references in memory. Once the key reference points are determined, they must be replicated in a medium that can be presented through computer software. The medium is unimportant, though sensory input is most efficiently absorbed by the brain in its natural form. For instance, if the experience to be transferred is based on the interpretation of moving objects, moving visuals should be used to convey all of the nuances. Animations and drawings are not nearly as effective as photographic media. The stimulus should be selected over a range of comparisons. In most cases there will be a right combination and a point at which the stimulus data becomes wrong. Wrong here may mean not appropriate, as well as incorrect depending on the experience-based pattern to be transferred. The stimulus data is initially presented with instructions on how interpretation is typically done. The instruction set helps to clarify key references if the learner needs that information, and can facilitate the learning if the user's experience is nominal. The stimulus data is presented at several levels of increasing difficulty. The number of levels will differ depending on the complexity of the data. Three is typical. At level one the data is presented for a block of time longer than would be found typically. For instance, if the experience needed was in recognizing dangerous objects traveling through the scanner at an airport, the initial observations would be made at a slower than normal speed. This helps the brain begin to assimilate the detail with less drop out or overload. If the objects would normally pass by in five seconds the first level might be presented in ten seconds, the middle tier in seven seconds and the final level at normal or slightly accelerated speeds. As the visuals pass by the screen the learner would be instructed to identify screens with suspicious objects. When they believe they have made a determination they would signal the computer through the mouse or other interface device and the visual data would disappear. They would than be required to identify the types of suspicious objects found in that visual. It is important to note that the visuals they identify are not simply a representation of the moving visual in a still format. The selection of objects must require interpolation and recognition without providing additional time to study the stimulus. This process helps the brain to interpret the data at speed without overwhelming it as it learns to sort correct from incorrect interpretations. The brain is learning to chunk key reference points to use for comparison in the same way trial and error would normally occur but without the lengthy time span or the need for as many trials. Feedback, as to level of correctness, is given immediately after selection by the learner and the learner then begins a new trial Once the learner's scores have reached acceptable levels and they are comfortable at the level, they should move up a level of difficulty. People learn at various speeds and comfort levels. The individual must be allowed to move up at his/her own pace or even skip levels if they choose. Recognition occurs naturally in leaps of ability as the brain moves to new levels. Some learners may require fifteen minutes and others a half an hour. Those that spent a half hour may be ready to jump two levels. The assimilation is idiosyncratic. Once the learner is comfortable at the highest level they are moved to a new variant. In this portion of the process, several stimulus segments are presented for interpretation and recognition at the highest level. No feedback is given here until the end of the trial series when they are given a score for each trial and an accumulated score. This section requires the brain to make a series of judgments in a real world fashion but still provides feedback to help internalize accuracy by requiring a heavy interpretive load as well as feedback. Scores are recorded by individual and can be used for comparison or refresher training when needed. Along with levels, stimuli may be presented by type, i.e., knives, guns, left handed versus right-handed. A higher level of difficulty for each speed level is random presentation of types. The software for presentation of the material is language independent as long as it has the functionality to build the above pattern. It must have variable menuing capabilities to allow for different numbers of levels of difficulty as required by the content. It must perform well with audio, video, photography and other forms for sensory stimulation including interfaces such as mouse, voice, touch screen, dance pads, virtual reality gloves and suits and any combination required to present the stimulus in a natural way. It must be capable of recognizing or tagging the stimulus data to match that data to interpretive outcomes to ensure that feedback is correctly correlated to the stimulation. The software is designed so that stimuli can be kept in individual files and extracted through arrays or similar processes for easy updating and randomization of delivery.

1. I claim the Accelerated Experiential Learning process of isolation of key information chunks from experts and the transference of those data bits as outlined above as a complete process.

2. I claim the software design for presenting the data in multi-tiered menu systems to provide variable levels of difficulty as step one with difficulty defined by both time of presentation and speed of activity compared to real time; followed by, step two, a mandatory identification of key elements with feedback to the user; followed by, step three, a rapid series of data presentations following the same presentation-identification pattern but with feedback delayed until the full trial sequence is complete.

3. I claim the use of data chunked for learning transfer in variable sets.

4. I claim the use of the specially designed software in the experience transfer process.

5. I claim the overall process referred to in this document as Accelerated Experiential Learning (AEL).

6. I claim the use of the AEL process for all computer based experience transfer applications.
